(19) United States
(12) Patent Application Publication
(10) Pub. No.: US 2025/0283570 A1
(43) Pub. Date: Sep. 11, 2025

(54) INSULATED SLEEVE CONNECTORS AND METHODS FOR CONNECTING DUCTS

(71) Applicant: The Boeing Company, Arlington, VA (US)

(72) Inventors: Bryce A. Van Dyke, Snohomish, WA (US); Edmund Fidelino P. Cordero, Lynnwood, WA (US); Douglas D. Maben, Snohomish, WA (US); Julia C. Williams, Mukilteo, WA (US)

(73) Assignee: The Boeing Company, Arlington, VA (US)

(21) Appl. No.: 18/596,912

(22) Filed: Mar. 6, 2024

(51) Int. Cl. F16L 59/18; F16L 21/00; F16L 23/04

(52) U.S. Cl. CPC F16L 59/182; F16L 21/002; F16L 23/04

(57) ABSTRACT

An insulated sleeve connector includes a tubular body having a longitudinal axis. The tubular body includes a first end including a first opening, a second end opposite the first end along the longitudinal axis and including a second opening, and a central section situated along the longitudinal axis between the first end and the second end and including an insulating material. The insulated sleeve connector also includes a first protrusion projecting from an inner surface of the tubular body adjacent to the central section and a second protrusion projecting from the inner surface of the tubular body adjacent to the central section and spaced away from the first protrusion along the longitudinal axis.

### FIELD

The present disclosure relates generally to duct systems and, more particularly, to insulated sleeve connectors that connect ducts together and methods for connecting ducts together using insulated sleeve connectors.

### BACKGROUND

Duct systems include ducts that are connected together to form passageways for moving fluid. Often, the ducts are connected together in an end-to-end fashion using a connector and/or clamps. One issue with existing duct systems is that it can be difficult to properly connect the ducts using conventional connectors. Improper connections can result in fluid leaks or disconnection of the ducts. Another issue with existing duct systems is that fluid passing between ends of the connected ducts is subject to ambient temperature. Accordingly, those skilled in the art continue with research and development efforts in duct systems.

### SUMMARY

Disclosed are examples of an insulated sleeve connector for connecting ducts together, a duct system connected using an insulated sleeve connector, and a method for connecting ducts together. The following is a non-exhaustive list of examples, which may or may not be claimed, of the subject matter according to the present disclosure.

In an example, the disclosed insulated sleeve connector includes a tubular body having a longitudinal axis. The tubular body includes a first end including a first opening, a second end opposite the first end along the longitudinal axis and including a second opening, and a central section situated along the longitudinal axis between the first end and the second end and including an insulating material. The insulated sleeve connector also includes a first protrusion projecting from an inner surface of the tubular body adjacent to the central section and a second protrusion projecting from the inner surface of the tubular body adjacent to the central section and spaced away from the first protrusion along the longitudinal axis.

In another example, the disclosed insulated sleeve connector includes a tubular body having a longitudinal axis. The tubular body includes a first end including a first opening, a second end opposite the first end along the longitudinal axis and including a second opening, and a central section situated along the longitudinal axis between the first end and the second end and including an insulating material. The insulated sleeve connector also includes a hinge disposed on the tubular body between the central section and the second end. A portion of the tubular body is configured to fold back along the longitudinal axis about the hinge.

In an example, the duct system includes a first duct, a second duct, and an insulated sleeve connector connecting the first duct and the second duct together. The insulated sleeve connector includes a tubular body having a longitudinal axis. The tubular body includes a first end including a first opening, a second end opposite the first end along the longitudinal axis and including a second opening, and a central section situated along the longitudinal axis between the first end and the second end and including an insulating material. The insulated sleeve connector also includes a first protrusion projecting from an inner surface of the tubular body adjacent to the central section and a second protrusion projecting from the inner surface of the tubular body adjacent to the central section and spaced away from the first protrusion along the longitudinal axis.

In another example, the duct system includes a first duct, a second duct, and an insulated sleeve connector connecting the first duct and the second duct together. The insulated sleeve connector includes a tubular body having a longitudinal axis. The tubular body includes a first end including a first opening, a second end opposite the first end along the longitudinal axis and including a second opening, and a central section situated along the longitudinal axis between the first end and the second end and including an insulating material. The insulated sleeve connector also includes a hinge disposed on the tubular body between the central section and the second end. A portion of the tubular body is configured to fold back along the longitudinal axis about the hinge.

In an example, the disclosed method includes steps of: (1) inserting a first duct into a first end of a tubular body of an insulated sleeve connector; (2) moving the first duct end past a first protrusion projecting from an inner surface of the tubular body adjacent to a central section of the tubular body situated along a longitudinal axis of the tubular body between the first end and a second end of the tubular body; (3) positioning a first duct end of the first duct within the central section of the tubular body; (4) inserting a second duct into a second end of the tubular body; (5) moving a second duct end past a second protrusion projecting from the inner surface of the tubular body adjacent to the central section and spaced away from the first protrusion along the longitudinal axis; (6) positioning the second duct end of the second duct within the central section of the tubular body such that a distance between the first duct end and the second duct end is less than a length dimension of the central section along the longitudinal axis; and (7) insulating a gap between the first duct end and the second duct end with the central section.

In another example, the disclosed method includes steps of: (1) inserting a first duct into a first end of a tubular body of the insulated sleeve connector; (2) positioning a first duct end of the first duct within a central section of the tubular body situated along a longitudinal axis of the tubular body between the first end and a second end of the tubular body; (3) folding a second section of the tubular body, extending along the longitudinal axis between the second end and the central section, back along the longitudinal axis about a hinge; (4) inserting a second duct into the second section of the tubular body; (5) unfolding the second section of the tubular body along the longitudinal axis about the hinge; (6) positioning a second duct end of the second duct within the central section of the tubular body such that a distance between the first duct end and the second duct end is less than a length dimension of the central section along the longitudinal axis; and (7) insulating a gap between the first duct end and the second duct end with the central section.

Also disclosed are examples of an aircraft that includes a duct system connected using an insulated sleeve connector.

Other examples of the insulated sleeve connector, the duct system, and the method will become apparent from the following detailed description, the accompanying drawings, and the appended claims.

### BRIEF DESCRIPTION OF THE DRAWINGS

FIG. 1 is a schematic block diagram of an example of an insulated sleeve connector;

FIG. 2 is a flow diagram of an example of a method for connecting ducts;

FIG. 3 is a schematic, perspective view of an example of the insulated sleeve connector;

FIG. 4 is a schematic, perspective view of an example of the insulated sleeve connector connecting a first duct and a second duct together;

FIG. 5 is a schematic, section view of an example of the insulated sleeve connector;

FIG. 6 is a schematic, section view of an example of the insulated sleeve connector connecting a first duct and a second duct together;

FIG. 7 is a schematic, section view of an example of the insulated sleeve connector connected to a first duct;

FIG. 8 is a schematic, section view of the example of the insulated sleeve connector shown in FIG. 7 connecting the first duct and a second duct together;

FIG. 9 is a schematic, section view of an example of the insulated sleeve connector;

FIG. 10 is a schematic, section view of an example of the insulated sleeve connector connecting a first duct and a second duct together;

FIG. 11 is a schematic, perspective view of an example of the insulated sleeve connector;

FIG. 12 is a schematic illustration of an example of a portion of a reinforcing band of the insulated sleeve connector shown in FIG. 11;

FIG. 13 is a schematic illustration of an example of the portion of the reinforcing band of the insulated sleeve connector shown in FIG. 12 in an expanded state;

FIG. 14 is a schematic, section view of an example of the insulated sleeve connector connecting a first duct and a second duct together;

FIG. 15 is a schematic, section view of an example of the insulated sleeve connector connecting a first duct and a second duct together;

FIG. 16 is a flow diagram of an example of an aircraft manufacturing and service method; and

FIG. 17 is a schematic illustration of an example of an aircraft.

### DETAILED DESCRIPTION

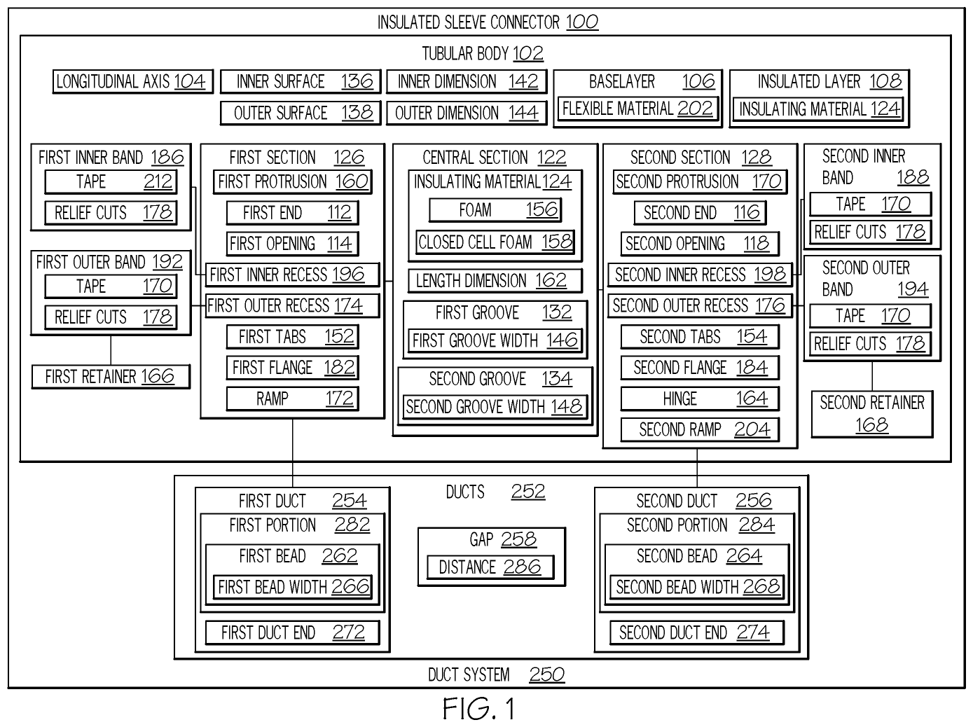

Referring generally to FIGS. 1-15, by way of examples, the present disclosure is directed to an insulated sleeve connector 100, a duct system 250 that includes ducts 252 connected using the insulated sleeve connector 100, and a method 1000 for connecting the ducts 252 using the insulated sleeve connector 100. Examples of the insulated sleeve connector 100 and method 1000 provide efficient connection of the ducts 252 to prevent fluid from escaping the duct system 250 and effective insulation of the fluid passing between the ducts 252 connected using the insulated sleeve connector 100.

Generally, the duct system 250 includes a first duct 254 and a second duct 256 (e.g., ducts 252), which are connected in an end-to-end orientation using examples the of insulated sleeve connector 100. In one particular example, the duct system 250 is an environmental control system (ECS) duct system on an aircraft. Examples of the insulated sleeve connector 100 connect the ECS ducts (e.g., ducts 252) in the end-to-end orientation. In various examples, the insulated sleeve connector 100 has an opening on each end and a number of pull tabs located around the perimeter of each opening. In various examples, the opening at each end of the insulated sleeve connector 100 is chamfered to facilitate installation onto the duct. In various examples, a middle section of the insulated sleeve connector 100 is suitably sized to ensure minimum duct separation requirements are met. In various examples, the middle section of the insulated sleeve connector 100 has a thickness and/or is made of a material suitable to insulate the entire duct joint.

Referring to FIG. 1, in one or more examples, the insulated sleeve connector 100 includes a number of elements, features, and components. The insulated sleeve connector 100 includes a tubular body 102. In various examples, at least a portion of the tubular body 102 includes or is made of an insulating material 124. In various examples, the tubular body 102 includes one or more of a first opening 114, a second opening 118, a first end 112, a second end 116, a first section 126, a second section 128, and a central section 122. In various examples, the insulated sleeve connector 100 also includes one or more of a first protrusion 160, a second protrusion 170, a first groove 132, a second groove 134, a hinge 164, a first retainer 166, a second retainer 168, a first inner recess 196, a second inner recess 198, a first outer recess 174, a second outer recess 176, a ramp 172, a second ramp 204, a plurality of first tabs 152, a plurality of second tabs 154, a first inner band 186, a second inner band 188, a first outer band 192, and a second outer band 194, among other elements, features, and components.

Referring to FIGS. 1 and 3-15, the following are examples of the insulated sleeve connector 100, according to the present disclosure. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

Referring to FIGS. 1 and 3-15, in one or more examples, the insulated sleeve connector 100 includes the tubular body 102. The tubular body 102 has a longitudinal axis 104. The tubular body 102 includes the first end 112. The tubular body 102 includes the first opening 114 at the first end 112. The tubular body 102 includes the second end 116. The second end 116 is opposite the first end 112 along the longitudinal axis 104. The tubular body 102 includes the second opening 118 at the second end 116. The tubular body 102 includes the central section 122. The central section 122 is situated along the longitudinal axis 104 between the first end 112 and the second end 116. The central section 122 includes or is made of the insulating material 124.

In various examples, the insulated sleeve connector 100 is configured to position the ducts 252 in an end-to-end orientation. In one or more examples, a distance 286 between the ends of the ducts 252 can vary. In one or more examples, the insulated sleeve connector 100 aligns the longitudinal axis of the first duct 254 to be co-axial with the longitudinal axis of the second duct 256. In other examples, the ducts 252 are aligned in an offset angular orientation (e.g., the longitudinal axes of the first duct 254 and the second duct 256 are not co-axial). In one or more examples, the insulated sleeve connector 100 is configured to space apart the ends of the first duct 254 and the second duct 256 to form a gap 258 between a first duct end 272 and a second duct end 274.

In one or more examples, the tubular body 102 of the insulated sleeve connector 100 has a cylindrical shape and forms a hollow or open interior space. In one or more examples, an inner dimension 142 (e.g., inner diameter) of the tubular body 102 is constant along the longitudinal axis 104. In one or more examples, the inner dimension 142 varies along the longitudinal axis 104. In one or more examples, the inner dimension 142 of the tubular body 102 at the first end 112 (e.g., the first opening 114) and at the second end 116 (e.g., the second opening 118) is the same. In one or more examples, the inner dimension 142 of the tubular body 102 at the first end 112 (e.g., the first opening 114) and at the second end 116 (e.g., the second opening 118) is different. Generally, the inner dimension 142 of the tubular body 102 at the first end 112 (e.g., the first opening 114) and at the second end 116 (e.g., the second opening 118) is configured to provide a snug fit around the first duct 254 and the second duct 256. In one or more examples, the insulated sleeve connector 100 is constructed from a material that expands during insertion of the ducts 252. In various examples, one or more portions or sections of the tubular body 102 can be made of fluorinated ethylene propylene (FEP), polytetrafluoroethylene (PTFE), plasticized vinyl, perfluoroalkoxy (PFA), polyvinylidene fluoride (PVDF), and the like.

As illustrated in FIGS. 4, 6-8, 9, 14 and 15, the insulated sleeve connector 100 connects the first duct 254 and the second duct 256 together and prevents fluid from escaping between the ducts 252. The tubular body 102 is an elongated body that includes or forms a hollow interior space configured to receive the ducts 252.

The first opening 114 of the tubular body 102 is configured to receive the first duct end 272 of the first duct 254 such that at least a first portion 282 of the first duct 254 is positioned within the first section 126 of the tubular body 102. The second opening 118 of the tubular body 102 is configured to receive a second duct end 274 of the second duct 256 such that at least a second portion 284 of the second duct 256 is positioned within the second section 128 of the tubular body 102.

In one or more examples, the tubular body 102 has a length, measured along the longitudinal axis 104, such that at least a portion of the first section 126 overlaps the first portion 282 of the first duct 254 and at least a portion of the second section 128 overlaps the second portion 284 of the second duct 256 and the central section 122 spans the gap 258 between the first duct end 272 and the second duct end 274.

In various examples, the insulated sleeve connector 100 properly positions the first duct end 272 and the second duct end 274 relative to each other when connecting the first duct 254 and the second duct 256 together. In various examples, the central section 122 insulates the gap 258 between the first duct end 272 and the second duct end 274. In various examples, the first section 126 and/or the second section 128 also insulate end portions of the ducts 252. The insulating effect is achieved by selection of the insulating material 124 used to form at least a portion of the insulated sleeve connector 100, a thickness of the tubular body 102, a thickness of the insulating material 124 used, and the like.

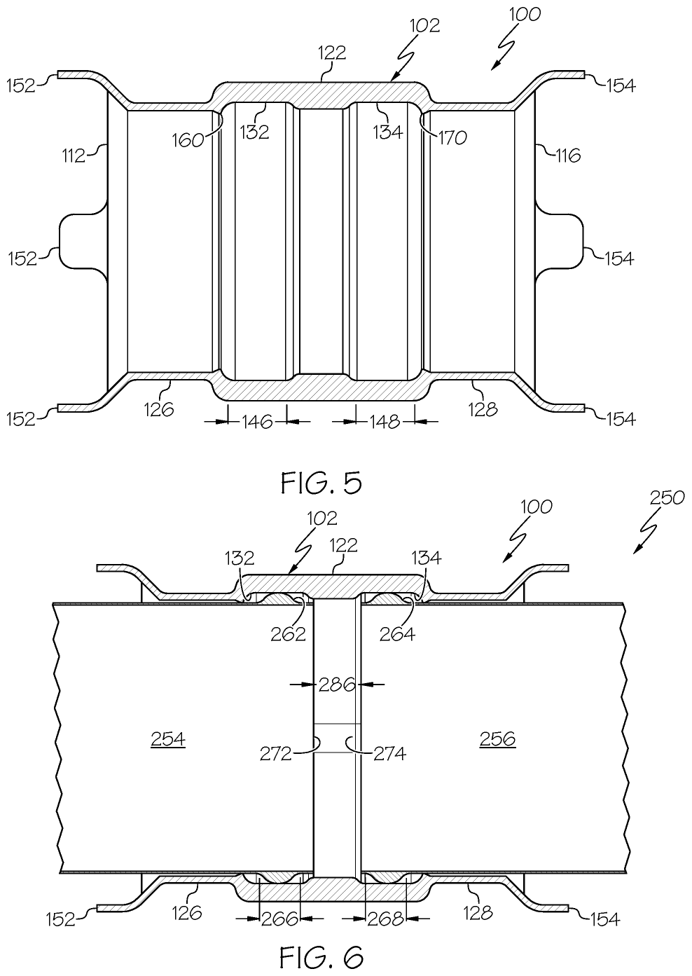

Referring generally to FIG. 1 and particularly to FIGS. 5, 6, 9 and 10, in one or more examples, the insulated sleeve connector 100 includes the first protrusion 160. The first protrusion 160 projects (e.g., radially inward) from the inner surface 136 of the tubular body 102. The first protrusion 160 is adjacent to the central section 122. The insulated sleeve connector 100 includes the second protrusion 170. The second protrusion 170 projects (e.g., radially inward) from the inner surface 136 of the tubular body 102. The second protrusion 170 is adjacent to the central section 122 and is spaced away from the first protrusion 160 along the longitudinal axis 104.

The first protrusion 160 serves to retain the first duct 254 within the first section 126 of the tubular body 102. Additionally, or alternatively, the first protrusion 160 also provides a tactile response (e.g., a snap) that indicates appropriate (e.g., full) insertion of the first duct 254 within the tubular body 102 and, thus, proper installation and connection of the insulated sleeve connector 100. Similarly, the second protrusion 170 serves to retain the second duct 256 within the second section 128 of the tubular body 102. Additionally, or alternatively, the second protrusion 170 also provides tactile response (e.g., a snap) that indicates appropriate (e.g., full) insertion of the second duct 256 within the tubular body 102 and, thus, proper installation and connection of the insulated sleeve connector 100.

In one or more examples, the first protrusion 160 and/or the second protrusion 170 have any suitable shape or structural configuration. As examples, the first protrusion 160 and/or the second protrusion 170 include or take the form of a bump, a tooth, a finger, and the like. In one or more examples, the first protrusion 160 and/or the second protrusion 170 are annular and extend continuously along a perimeter of the inner surface 136. In one or more examples, the first protrusion 160 and/or the second protrusion 170 are discontinuous and are formed by a series of protrusions that extend along a perimeter of the inner surface 136. In one or more examples, the first protrusion 160 and/or the second protrusion 170 includes a number of adjacent protrusions that extend along the longitudinal axis 104. In one or more examples, the first protrusion 160 and/or the second protrusion 170 are formed by or represent a reduction in an inner dimension 142 (e.g., inner diameter) of the tubular body 102 relative to other portions of the tubular body 102.

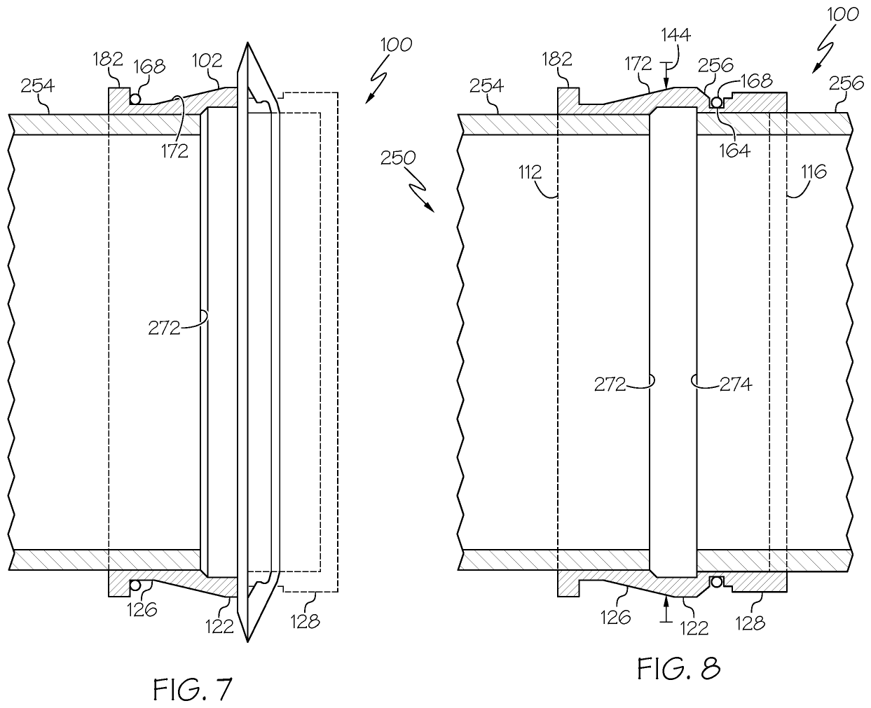

Referring generally to FIG. 1 and particularly to FIGS. 7 and 8, in one or more examples, the insulated sleeve connector 100 includes the hinge 164. The hinge 164 is disposed on the tubular body 102 between the central section 122 and the second end 116. A portion of the tubular body 102 is configured to fold back upon itself along the longitudinal axis 104 about the hinge 164 and then unfold to its original configuration.

FIG. 7 illustrates an example of the insulated sleeve connector 100 with a portion of the tubular body 102 folded back upon itself along the hinge 164. FIG. 8 illustrates an example of the insulated sleeve connector 100 shown in FIG. 7 connected to the second duct 256. The hinge 164 enables length of the tubular body 102 along the longitudinal axis 104 to be temporarily reduced for installation of the insulated sleeve connector 100, such as during insertion of one of the ducts 252 when connecting the ducts 252 together using the insulated sleeve connector 100. The hinge 164 can include or take the form of any structure capable of enabling one portion of the tubular body 102 to fold or roll back upon itself and then return to its original position. In one or more examples, the hinge 164 is annular and extends continuously along a perimeter of the inner surface 136 or an outer surface 138 of the tubular body 102. Examples of the hinge 164 include a recess formed in the inner surface 136 of the tubular body 102 (e.g., a reduction in the inner dimension 142), a recess formed in the outer surface 138 of the tubular body 102 (e.g., a reduction in an outer dimension 144), a score formed along a perimeter of the inner surface 136 and/or the outer surface 138, a living hinge, and the like.

Referring to FIG. 1, in one or more examples of the insulated sleeve connector 100, the insulating material 124 includes or is made of foam 156. In one or more examples of the insulated sleeve connector 100, the insulating material 124 includes or is made of closed cell foam 158. In one or more examples, the insulating material 124 includes or is made of silicone. In one or more examples, the insulating material 124 includes or is made of polyvinylidene fluoride or polyvinylidene difluoride (PVDF). In one or more examples, the insulating material 124 includes or is made of polyethylene (PE) or the like. In one or more examples of the insulated sleeve connector 100, at least one of the first section 126 and the second section 128 of the tubular body 102 includes or is made of the insulating material 124.

Referring to FIGS. 1, 3-11, 14 and 15, in one or more examples of the insulated sleeve connector 100, the tubular body 102 includes the first section 126. The first section 126 extends along the longitudinal axis 104 between the first end 112 and the central section 122. The tubular body 102 includes the second section 128. The second section 128 extends along the longitudinal axis 104 between the second end 116 and the central section 122. The first section 126 of the tubular body 102 is configured to receive the first duct 254. The second section 128 of the tubular body 102 is configured to receive the second duct 256.

Referring generally to FIG. 1 and particularly to FIG. 6, in one or more examples of the insulated sleeve connector 100, the central section 122 of the tubular body 102 has a length dimension 162. The length dimension 162 is measured along the longitudinal axis 104. The length dimension 162 is greater than a distance 286 between the first duct end 272 of the first duct 254 and the second duct end 274 of the second duct 256 when the first duct 254 is received by the first section 126 and the second duct 256 is received by the second section 128. The distance 286 is measured along the longitudinal axis 104 of the tubular body 102.

The length dimension 162 of the central section 122 of the tubular body 102 being greater than the distance 286 between the first duct end 272 of the first duct 254 and the second duct end 274 of the second duct 256 insulates the gap 258 between the first duct end 272 of the and the second duct end 274 and, thus, insulates the fluid passing between the first duct 254 and the second duct 256.

Referring to FIGS. 1, 5, 6, 9 and 10, in one or more examples of the insulated sleeve connector 100, the first protrusion 160 is located at a first junction of the first section 126 and the central section 122. The first protrusion 160 provides a first tactile response to insertion of the first duct 254 and assists in retaining the first duct 254 within the first section 126. The second protrusion 170 is located at a second junction of the second section 128 and the central section 122. The second protrusion 170 provides a second tactile response to insertion of the second duct 256 and assists in retaining the second duct 256 within the second section 128. Additionally, in one or more examples, the tactile response (e.g., a snap) provided by the first protrusion 160 and/or the second protrusion 170 also indicates appropriate (e.g., full and correct) insertion of the first duct 254 and/or the second duct 256 within the tubular body 102 and, thus, proper installation and connection of the insulated sleeve connector 100 on the ducts 252.

As illustrated in FIGS. 5 and 6, in various examples of the duct system 250, the first duct 254 includes a first bead 262 that extends or projects radially outward from an outer surface of the first duct 254. Similarly, in various examples of the duct system 250, the second duct 256 includes a second bead 264 that extends or projects radially outward from an outer surface of the second duct 256. In some examples, the first bead 262 is located at the first duct end 272 of the first duct 254 and/or the second bead 264 is located at the second duct end 274 of the second duct 256. In other examples, the first bead 262 is spaced inward of the first duct end 272 of the first duct 254 and/or the second bead 264 is spaced inward of the second duct end 274 of the second duct 256. The first bead 262 and the second bead 264 can have various structural configurations and can include, for example, beads, bends, or other structures formed by the ducts 252 or connected to the ducts 252. In the illustrated examples, the first bead 262 is a bead formed along a perimeter of the outer surface of the first duct 254 and the second bead 264 is a bead formed along a perimeter of the outer surface of the second duct 256. In one or more examples, the tubular body 102 of the insulated sleeve connector 100 is configured to accommodate the first bead 262 and the second bead 264 during insertion of the ducts 252 and installation of the insulated sleeve connector 100.

Referring to FIGS. 1, 5 and 6, in one or more examples, the insulated sleeve connector 100 includes the first groove 132. The first groove 132 is disposed on the inner surface 136 of the tubular body 102 along the central section 122, wherein the first groove 132 is configured to receive the first bead 262 of the first duct 254. The insulated sleeve connector 100 also includes the second groove 134. The second groove 134 is disposed on the inner surface 136 of the tubular body 102 along the central section 122. The second groove 134 is spaced from the first groove 132 along the longitudinal axis 104. The second groove 134 is configured to receive the second bead 264 of the second duct 256.

As illustrated in FIGS. 5 and 6, the first groove 132 is configured to receive and capture the first bead 262 of the first duct 254 as the first duct 254 is moved along the longitudinal axis 104 relative to the tubular body 102. The first groove 132 is also configured to retain the first bead 262 and, thus, the first duct end 272 of the first duct 254 at an appropriate (e.g., fully inserted) position within the tubular body 102 and relative to the second duct end 274 of the second duct 256 when the ducts 252 are connected together such that a proper instance of the distance 286 of the gap 258 between the ducts 252 is maintained. Similarly, the second groove 134 is configured to receive and capture the second bead 264 of the second duct 256 as the second duct 256 is moved along the longitudinal axis 104 relative to the tubular body 102. The second groove 134 is also configured to retain the second bead 264 and, thus, the second duct end 274 of the second duct 256 at an appropriate (e.g., fully inserted) position within the tubular body 102 and relative to the first duct end 272 of the first duct 254 when the ducts 252 are connected together such that a proper instance of the distance 286 of the gap 258 between the ducts 252 is maintained.

In one or more examples, the first groove 132 also provides a tactile response (e.g., a snap) that indicates appropriate (e.g., full) insertion of the first duct 254 within the tubular body 102 and, thus, proper installation and connection of the insulated sleeve connector 100. Similarly, the second groove 134 provides tactile response (e.g., a snap) that indicates appropriate (e.g., full) insertion of the second duct 256 within the tubular body 102 and, thus, proper installation and connection of the insulated sleeve connector 100.

In one or more examples, the first groove 132 depends (e.g., radially inward) from the inner surface 136 of the central section 122 of the tubular body 102. In one or more examples, the first groove 132 is adjacent to an interface between the central section 122 and the first section 126. In one or more examples, an outward end of the first groove 132 includes or is formed by the first protrusion 160. In one or more examples, the second groove 134 depends (e.g., radially inward) from the inner surface 136 of the central section 122 of the tubular body 102. In one or more examples, the second groove 134 is adjacent to an interface between the central section 122 and the second section 128. In one or more examples, an outward end of the second groove 134 includes or is formed by the second protrusion 170.

In one or more examples, the first groove 132 and/or the second groove 134 have any suitable shape or structural configuration. As examples, the first groove 132 and/or the second groove 134 include or take the form of a recess, a slot, a depression, and the like. In one or more examples, the first groove 132 and/or the second groove 134 are annular and extend continuously along a perimeter of the inner surface 136 of the central section 122. In one or more examples, the first groove 132 and/or the second groove 134 are discontinuous and are formed by a series of gouges that extend along a perimeter of the inner surface 136. In one or more examples, the first groove 132 and/or the second groove 134 are formed by or represent a reduction in the inner dimension 142 (e.g., inner diameter) of the central section 122 of tubular body 102 relative to other portions (e.g., outward and/or inward portions) of the central section 122 of the tubular body 102.

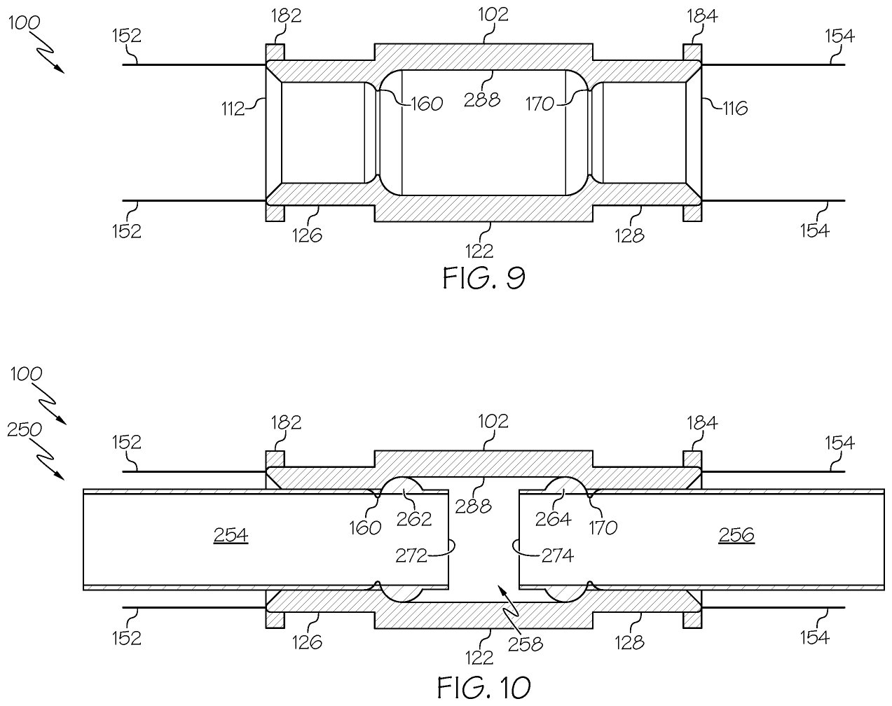

Referring to FIGS. 9 and 10, in other examples, the insulated sleeve connector 100 includes a single instance of a groove 288. The groove 288 is disposed on the inner surface 136 of the tubular body 102 along the central section 122. In these examples, the groove 288 is configured to receive, capture, and/or retain the first bead 262 of the first duct 254 and the second bead 264 of the second duct 256. In one or more examples, opposing ends of the groove 288 include or are formed by the first protrusion 160 and the second protrusion 170. In one or more examples, the groove 288 is formed by or represents a reduction in the inner dimension 142 (e.g., inner diameter) of the central section 122 of tubular body 102 relative to other portions (e.g., outward portions) of the central section 122 of the tubular body 102.

Referring to FIGS. 1, 5 and 6, in one or more examples of the insulated sleeve connector 100, the first groove 132 has a first groove width 146 (FIG. 5). The first groove width 146 measured along the longitudinal axis 104. The first groove width 146 is larger than a first bead width 266 (FIG. 6) of the first bead 262. Similarly, in one or more examples of the insulated sleeve connector 100, the second groove 134 has a second groove width 148 (FIG. 5.) The second groove width 148 is measured along the longitudinal axis 104. The second groove width 148 is larger than a second bead width 268 (FIG. 6) of the second bead 264.

The first groove width 146 being slightly larger than the first bead width 266 enables the first groove 132 to efficiently receive and retain the first bead 262. The first groove width 146 being larger than the first bead width 266 also permits the first duct 254 to shift or move a small distance relative to the insulated sleeve connector 100. The second groove width 148 being slightly larger than the second bead width 268 enables the second groove 134 to efficiently receive and retain the second bead 264. The second groove width 148 being larger than the second bead width 268 also permits the second duct 256 to shift or move a small distance relative to the insulated sleeve connector 100.

Referring to FIGS. 1, 7 and 8, in one or more examples of the insulated sleeve connector 100, the second section 128 of the tubular body 102 includes the hinge 164. As illustrated in FIG. 7, in these examples, the hinge 164 is located inward of the second end 116. A portion (e.g., an outward portion) of the second section 128 is configured to fold back upon another portion (e.g., an inward portion) of the second section 128 along the longitudinal axis 104 about the hinge 164. In the hinged state, or inwardly folded configuration, the length of the tubular body 102 along the longitudinal axis 104 is reduced such that the second duct end 274 of the second duct 256 can be more easily inserted in the second section 128 and positioned relative to the central section 122. As illustrated in FIG. 8, after the second duct 256 is installed, the folded portion of the second section 128 can be unfolded or returned to its original configuration.

Referring to FIGS. 1 and 4, in one or more examples, the insulated sleeve connector 100 includes at least one of the first retainer 166 and/or the second retainer 168. The first retainer 166 and/or the second retainer 168 are applied to the tubular body 102 and are configured to apply a radially inward compressive force that secures and maintains the tubular body 102 around the ducts 252. In one or more examples, the first retainer 166 and the second retainer 168 have an annular shape and extend around a perimeter of the outer surface 138 of the first section 126 and the second section 128, respectively. The first retainer 166 and/or the second retainer 168 can include any suitable clamp, strap, fitting, O-ring, cable tie, and the like.

Referring to FIGS. 1, 7 and 8, in one or more examples, the insulated sleeve connector 100 includes at least the second retainer 168. The hinge 164 is configured to receive the second retainer 168. As an example, the hinge 164 can include or take the form of a recess or channel formed in the outer surface 138 of the second section 128. The second retainer 168 is configured to be seated or received within the open space formed by the hinge 164. In one or more of these examples, the second retainer 168 includes or takes the form of an O-ring or other flexible retainer.

Referring still to FIGS. 1, 7 and 8, in one or more examples of the insulated sleeve connector 100, the tubular body 102 has an outer dimension 144 (FIG. 8) along the first section 126. The outer dimension 144 along at least a portion of the first section 126 increases from the first end 112 to the central section 122 to form the ramp 172. The second retainer 168 is movable along the ramp 172 between the first section 126 and the second section 128.

Referring still to FIGS. 1, 7 and 8, in one or more examples of the insulated sleeve connector 100, the outer dimension 144 of a portion of the tubular body 102 along at least a portion of the second section 128 increases from the second end 116 to the central section 122 to form a second ramp 204. As an example, the outer dimension 144 along a portion of the second section 128 increases from an inward end of the hinge 164 to the central section 122 to form the second ramp 204 (e.g., as shown in FIG. 8). In these examples, the ramp 172 can also be referred to as a first ramp. The second retainer 168 is movable along the second ramp 204 between the second section 128 and the first section 126.

Movement of the second retainer 168 from the second section 128 (e.g., as shown in FIG. 8) to the first section 126 (e.g., as shown in FIG. 7), for example, over the second ramp 204, the central section 122, and the ramp 172, repositions the second retainer 168 (e.g., O-ring) such that the second section 128 can be inwardly folded about the hinge 164. Movement of the second retainer 168 from the first section 126 (e.g., as shown in FIG. 7) back to the second section 128 (e.g., as shown in FIG. 8), for example, over the ramp 172, the central section 122, and the second ramp 204, repositions the second retainer 168 (e.g., O-ring) back into the hinge 164 to maintain the second section 128 around the second duct 256.

Referring to FIGS. 1, 4-6, 9-11, 14 and 15, in one or more examples, the insulated sleeve connector 100 includes a number of first tabs 152. The first tabs 152 extend outwardly from and beyond the first end 112 of the tubular body 102 along the longitudinal axis 104. The first tabs 152 serve as grips that provide a structure for a user to grasp and apply a force to the tubular body 102, for example, to slide the first section 126 onto the first duct end 272 of the first duct 254, when installing the insulated sleeve connector 100 on the first duct 254.

Referring still to FIGS. 1, 4-6, 9-11 and 15, in one or more examples, the insulated sleeve connector 100 includes a number of second tabs 154. The second tabs 154 extend outwardly from and beyond the second end 116 of the tubular body 102 along the longitudinal axis 104. The second tabs 154 serve as grips that provide a structure for a user to grasp, for example, to slide the first section 126 onto the first duct end 272 of the first duct 254, when installing the insulated sleeve connector 100 on the second duct 256.

Referring to FIGS. 4-6, 9-11 and 15, in one or more examples of the insulated sleeve connector 100, in one or more examples, the first tabs 152 extend from a perimeter of the first opening 114. In one or more examples, the first tabs 152 are spaced apart from each other around the perimeter of the first opening 114. In one or more examples, each one of the first tabs 152 is equally angularly spaced from a directly adjacent one of the first tabs 152 around the first opening 114.

Referring to FIGS. 4-6, 9-11 and 15, in one or more examples of the insulated sleeve connector 100, the second tabs 154 extend from a perimeter of the second opening 118. In one or more examples, the second tabs 154 are spaced apart from each other around the perimeter of the second opening 118. In one or more examples, each one of the second tabs 154 is equally angularly spaced from a directly adjacent one of the second tabs 154 around the second opening 118.

Referring to FIGS. 4-6, 9-11 and 15, in one or more examples of the insulated sleeve connector 100, at least a portion of at least one of the first tabs 152 is oriented at an oblique angle relative to the longitudinal axis 104. For example, the first tabs 152 are flared radially outward. In one or more examples, the first tabs 152 are aligned at least approximately parallel to the longitudinal axis 104.

Referring to FIGS. 4-6, 9-11 and 15, in one or more examples of the insulated sleeve connector 100, at least a portion of at least one of the second tabs 154 is oriented at an oblique angle relative to the longitudinal axis 104. For example, the second tabs 154 are flared radially outward. In one or more examples, the second tabs 154 are aligned at least approximately parallel to the longitudinal axis 104.

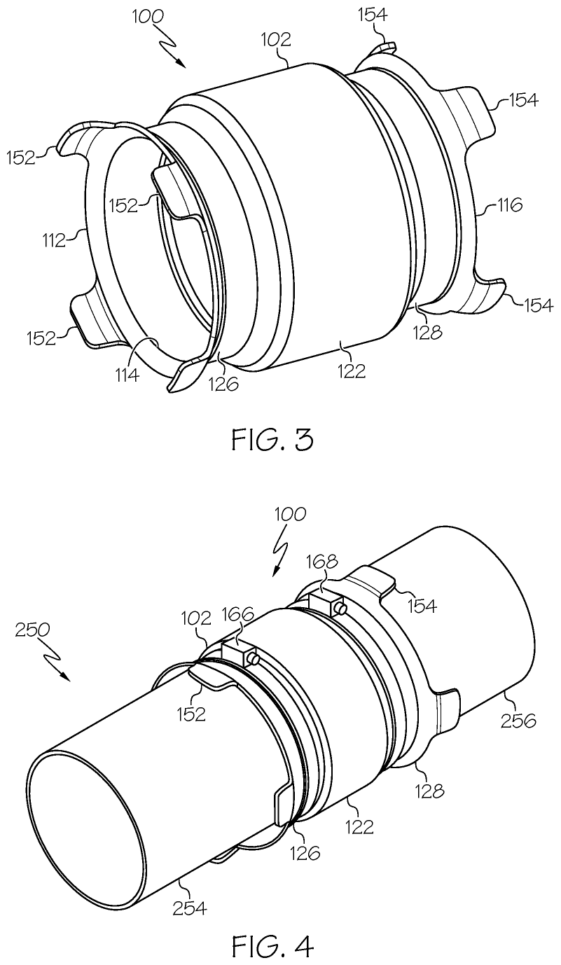

Referring to FIGS. 3-6, in one or more examples, tubular body 102 includes a first flared portion at the first end 112 and a second portion section at the second end 116. In these examples, the flared portions extend outward along the longitudinal axis 104 away from the first section 126 and the second section 128, respectively. The first flared portion represents an increase in the inner dimension 142 (e.g., inner diameter) of the outward portion of the first section 126 relative to the inward portion of the first section 126. The second flared portion represents an increase in the inner dimension 142 (e.g., inner diameter) of the outward portion of the second section 128 relative to the inward portion of the second section 128. The flared portions serve as a funnel to direct the ends of the ducts 252 and facilitate insertion of the first duct 254 and second duct 256 into the tubular body 102 of the insulated sleeve connector 100. In some examples, the first flared portion also serves to maintain the first retainer 166 on the first section 126. In some examples, the second flared portion also serves to maintain the second retainer 168 on the second section 128 (e.g., as shown in FIG. 4).

Referring to FIGS. 3-6, in one or more examples, the first tabs 152 extend outward from the first flared section of the first section 126. In one or more examples, the second tabs 154 extend outward from the second flared portion of the second section 128.

Referring to FIGS. 1 and 9-11, in one or more examples, the insulated sleeve connector 100 includes the first flange 182. The first flange 182 extends from the first section 126 of the tubular body 102 at the first end 112. In one or more examples, the first flange 182 projects radially outward from the outer surface 138 of the first section 126. In one or more examples, the first flange 182 is located at or near the first end 112. In one or more examples, the first flange 182 is annular and extends around the perimeter of the outer surface 138 of the first section 126. In these examples, the first flange 182 serves to maintain the first retainer 166 on the first section 126.

Referring to FIGS. 1 and 9-11, in one or more examples, the insulated sleeve connector 100 includes the second flange 184. The second flange 184 extends from the second section 128 of the tubular body 102 at the second end 116. In one or more examples, the second flange 184 projects radially outward from the outer surface 138 of the second section 128. In one or more examples, the second flange 184 is located at or near the second end 116. In one or more examples, the second flange 184 is annular and extends around the perimeter of the outer surface 138 of the second section 121286. In these examples, the second flange 184 serves to maintain the second retainer 168 on the second section 128.

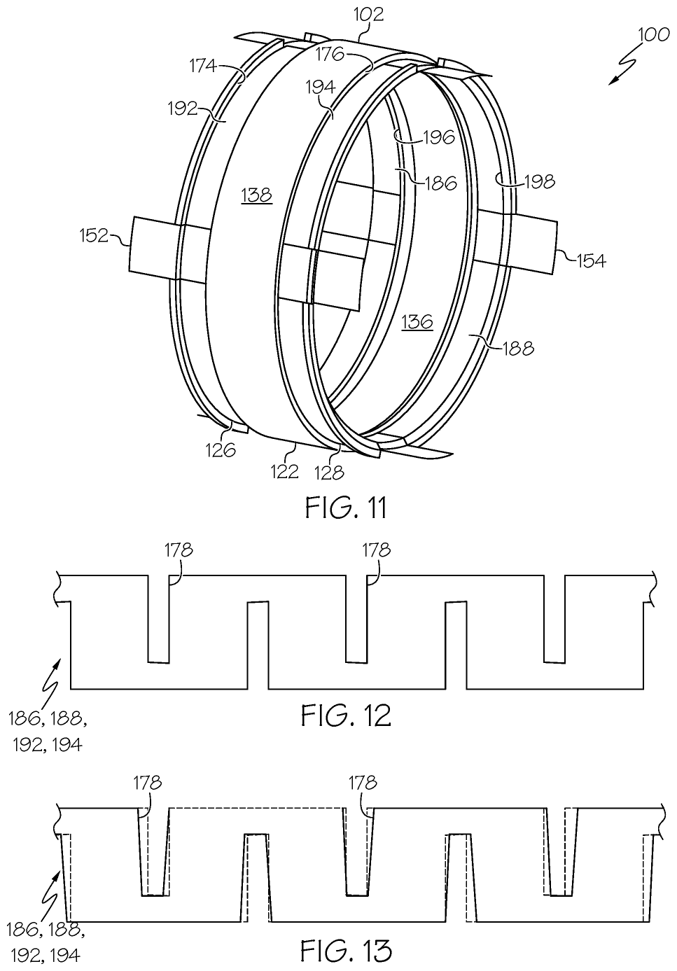

Referring to FIGS. 1 and 11, in one or more examples, the insulated sleeve connector 100 includes the first inner band 186. The first inner band 186 is coupled to the inner surface 136 of the first section 126 of the tubular body 102. In one or more examples, the first inner band 186 is located proximate (e.g., at or near) the first end 112. In these examples, the first inner band 186 protects the material of the tubular body 102 from wear or damage. Additionally, or alternatively, the first inner band 186 structurally reinforces or strengthens a portion of the first section 126, such as the portion that receives the first retainer 166.

Referring to FIGS. 1 and 11, in one or more examples, the insulated sleeve connector 100 includes the second inner band 188. The second inner band 188 is coupled to the inner surface 136 of the second section 128 of the tubular body 102. In one or more examples, the second inner band 188 is located proximate (e.g., at or near) the second end 116. In these examples, the second inner band 188 protects the material of the tubular body 102 from wear or damage. Additionally, or alternatively, the second inner band 188 structurally reinforces or strengthens a portion of the second section 128, such as the portion that receives the second retainer 168.

Referring to FIGS. 1 and 11, in one or more examples, the insulated sleeve connector 100 includes the first outer band 192. The first outer band 192 is coupled to the outer surface 138 of the first section 126 of the tubular body 102. In one or more examples the first outer band 192 is located proximate (e.g., at or near) the first end 112. In one or more examples, the first outer band 192 is located opposite the first inner band 186. In these examples, the first outer band 192 protects the material of the tubular body 102 from wear or damage. Additionally, or alternatively, the first outer band 192 structurally reinforces or strengthens a portion of the first section 126, such as the portion that receives the first retainer 166.

Referring to FIGS. 1 and 11, in one or more examples, the insulated sleeve connector 100 includes the second outer band 194. The second outer band 194 is coupled to the outer surface 138 of the second section 128 of the tubular body 102. In one or more examples, the second outer band 194 is located proximate (e.g., at or near) the second end 116. In one or more examples, the second outer band 194 is located opposite the second inner band 188. In these examples, the second outer band 194 protects the material of the tubular body 102 from wear or damage. Additionally, or alternatively, the second outer band 194 structurally reinforces or strengthens a portion of the second section 128, such as the portion that receives the second retainer 168.

Referring to FIGS. 1 and 11, in one or more examples, the insulated sleeve connector 100 includes the first outer recess 174. The first outer recess 174 is disposed on (e.g., depends radially inward from) the outer surface 138 of the first section 126 of the tubular body 102, for example, proximate (e.g., at or near) the first end 112. In one or more examples of the insulated sleeve connector 100, the first outer band 192 is disposed in the first outer recess 174. In one or more examples, the first retainer 166 is also disposed in the first outer recess 174 over the first outer band 192. In these examples, the first outer recess 174 serves to retain the first retainer 166 around the first section 126. In some examples, the first outer recess 174 represents a reduction in the outer dimension 144 (e.g., outer diameter) of a portion of the first section 126 relative to another portion of the first section 126.

Referring to FIGS. 1 and 11, in one or more examples, the insulated sleeve connector 100 includes the second outer recess 176. The second outer recess 176 is disposed on (e.g., depends radially inward from) the outer surface 138 of the second section 128 of the tubular body 102, for example, proximate (e.g., at or near) the second end 116. In one or more examples of the insulated sleeve connector 100, the second outer band 194 is disposed in the second outer recess 176. In one or more examples, the second retainer 168 is also disposed in the second outer recess 176 over the second outer band 194. In these examples, the second outer recess 176 serves to retain the second retainer 168 around the second section 128. In some examples, the second outer recess 176 represents a reduction in the outer dimension 144 (e.g., outer diameter) of a portion of the second section 128 relative to another portion of the second section 128.

Referring to FIGS. 1 and 11, in one or more examples, the insulated sleeve connector 100 includes the first inner recess 196. The first inner recess 196 is disposed on (e.g., depends radially outward from) the inner surface 136 of the first section 126 of the tubular body 102, for example, proximate (e.g., at or near) the first end 112. In one or more examples of the insulated sleeve connector 100, the first inner band 186 is disposed in the first inner recess 196. In some examples, the first inner recess 196 represents an increase in the inner dimension 142 (e.g., inner diameter) of a portion of the first section 126 relative to another portion of the first section 126.

Referring to FIGS. 1 and 11, in one or more examples, the insulated sleeve connector 100 includes the second inner recess 198. The second inner recess 198 is disposed on (e.g., depends radially outward from) the inner surface 136 of the second section 128 of the tubular body 102, for example, proximate (e.g., at or near) the second end 116. In one or more examples of the insulated sleeve connector 100, the second inner band 188 is disposed in the second inner recess 198. In some examples, the second inner recess 198 represents an increase in the inner dimension 142 (e.g., inner diameter) of a portion of the second section 128 relative to another portion of the second section 128.

Referring to FIGS. 1 and 11-13, in one or more examples of the insulated sleeve connector 100, at least one, or each one, of the first inner band 186, the first outer band 192, the second inner band 188, and/or the second outer band 194 includes relief cuts 178. The relief cuts 178 enable expansion of the first inner band 186, the first outer band 192, the second inner band 188, and/or the second outer band 194 and, thus, expansion of the tubular body 102 during insertion of one of the ducts 252. FIG. 12 illustrates an example of the relief cuts 178 formed in a portion of one of the bands (e.g., first inner band 186, first outer band 192, second inner band 188, and/or second outer band 194). FIG. 13 illustrates an example of the portion of the band shown in FIG. 12 (e.g., first inner band 186, first outer band 192, second inner band 188, and/or second outer band 194) in an expanded state, thereby, enabling radial expansion of a portion of the tubular body 102 that includes the band (e.g., the first section 126 and/or the second section 128).

Referring to FIG. 1, in one or more examples of the insulated sleeve connector 100, at least one, or each one, of the first inner band 186, the first outer band 192, the second inner band 188, and/or the second outer band 194 includes or is made of tape 212. In one or more examples, the tape 212 is an adhesive-backed strip tape.

Referring to FIGS. 1 and 11, in one or more examples, the insulated sleeve connector 100 includes the first tabs 152. The first tabs 152 are coupled to at least one of the first inner band 186 and first outer band 192. The first tabs 152 extend outwardly from the first end 112 along the longitudinal axis 104. In one or more examples, the first tabs 152 include or are formed by the tape 212.

Referring to FIGS. 1 and 11, in one or more examples, the insulated sleeve connector 100 includes a number of the second tabs 154. The second tabs 154 are coupled to at least one of the second inner band 188 and the second outer band 194. The second tabs 154 extend outwardly from the second end 116 along the longitudinal axis 104. In one or more examples, the second tabs 154 include or are formed by the tape 212.

Referring to FIGS. 1, 14 and 15, in one or more examples of the insulated sleeve connector 100, the tubular body 102 includes the base layer 106. The base layer 106 includes or is made of a flexible material 202. In one or more examples, the flexible material 202 includes or is made of silicone. In one or more examples, the flexible material 202 includes or is made of a fiber-reinforced (e.g., fiberglass) substrate. The tubular body 102 also includes the insulated layer 108. The insulated layer 108 is coupled to the base layer 106. The insulated layer 108 includes or is made of the insulating material 124. In one or more examples, the insulated layer 108 and the base layer 106 are bonded together.

Referring still to FIGS. 1, 14 and 15, in one or more examples of the insulated sleeve connector 100, at least a portion of the insulated layer 108 is coupled to an inner side 208 of the base layer 106, for example, facing the hollow interior of the tubular body 102 and the ducts 252. In one or more examples of the insulated sleeve connector 100, at least a portion of the insulated layer 108 is coupled to an outer side 206 of the base layer 106, for example, facing away from the hollow interior of the tubular body 102 and the ducts 252. In one or more examples, a portion of the insulated layer 108 is coupled to the outer side 206 of the base layer 106 and another portion of the insulated layer 108 is coupled to the inner side 208 of the base layer 106. In various examples, the insulated layer 108 can be on the outer side 206, the inner side 208, or both along the central section 122 of the tubular body 102. In other examples, the insulated layer 108 can be on the outer side 206, the inner side 208, or both along the first section 126 and/or the second section 128 of the tubular body 102.

In one or more examples, the insulated layer 108 includes or is made up of a number of layers of the insulating material 124. In one or more examples, a portion of the insulated layer 108 that is located on the inside of the insulated sleeve connector 100 (e.g., coupled to the inner side 208 of the base layer 106) also provides a substantially similar effect as the first protrusion 160 and the second protrusion 170, which is to provide positive tactile indication of engagement over the ends and/or beads of the ducts 252. In addition, in one or more examples, bands or strips of the insulated layer 108 can be used on the inside of the insulated sleeve connector 100 that include or are made of a closed cell foam or an elastomer to minimize air leakage.

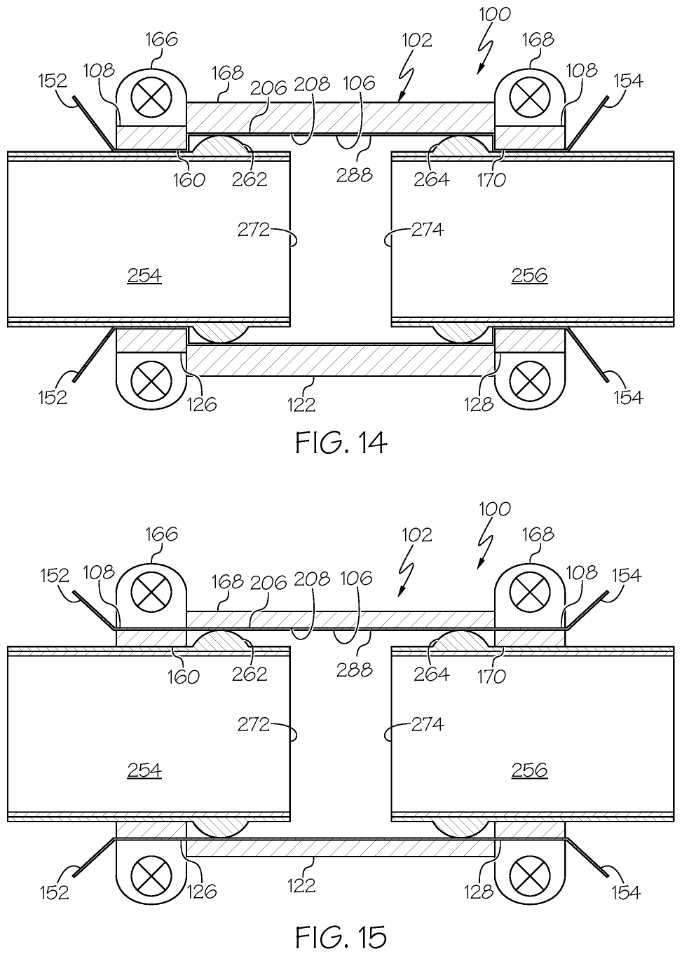

Referring to FIGS. 14 and 15, in one or more examples of the insulated sleeve connector 100, the base layer 106 (e.g., the flexible material 202) extends outwardly from the insulated layer 108 along the longitudinal axis 104 from the first end 112 to form the first tabs 152 that extend outwardly from the first end 112 and/or around the perimeter of the first opening 114. Similarly, in one or more examples of the insulated sleeve connector 100, the base layer 106 extends outwardly from the insulated layer 108 along the longitudinal axis 104 from the second end 116 to form the second tabs 154 the extend outwardly from the second end 116 and/or around the perimeter of the first opening 114.

Referring now to FIGS. 1 and 3-15, the following are examples of the duct system 250, according to the present disclosure. The duct system 250 includes a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein. The examples of the duct system 250 can be utilized with any one of the examples of the insulated sleeve connector 100 described herein and illustrated in FIGS. 1 and 3-15.

Referring to FIGS. 1 and 3-15, in one or more examples, the duct system 250 includes the first duct 254, the second duct 256, and the insulated sleeve connector 100 connecting the first duct 254 and the second duct 256 together. The insulated sleeve connector 100 includes the tubular body 102 having the longitudinal axis 104. The tubular body 102 includes the first end 112 that includes the first opening 114. The tubular body 102 includes the second end 116, opposite the first end 112 along the longitudinal axis 104. that includes the second opening 118. The tubular body 102 includes the central section 122 that is situated along the longitudinal axis 104 between the first end 112 and the second end 116. The central section 122 includes or is made of the insulating material 124.

Referring to FIGS. 1, 3-10 14 and 15, in one or more examples of the duct system 250, the insulated sleeve connector 100 includes the first protrusion 160. The first protrusion 160 projects from the inner surface 136 of the tubular body 102 adjacent to the central section 122. The insulated sleeve connector 100 includes the second protrusion 170. The second protrusion 170 projects from the inner surface 136 of the tubular body 102 adjacent to the central section 122. The second protrusion 170 is spaced away from the first protrusion 160 along the longitudinal axis 104.

Referring to FIGS. 1, 7 and 8, in one or more examples of the duct system 250, the insulated sleeve connector 100 includes the hinge 164 that is disposed on the tubular body 102 between the central section 122 and the second end 116. A portion of the tubular body 102 is configured to fold back along the longitudinal axis 104 about the hinge 164.

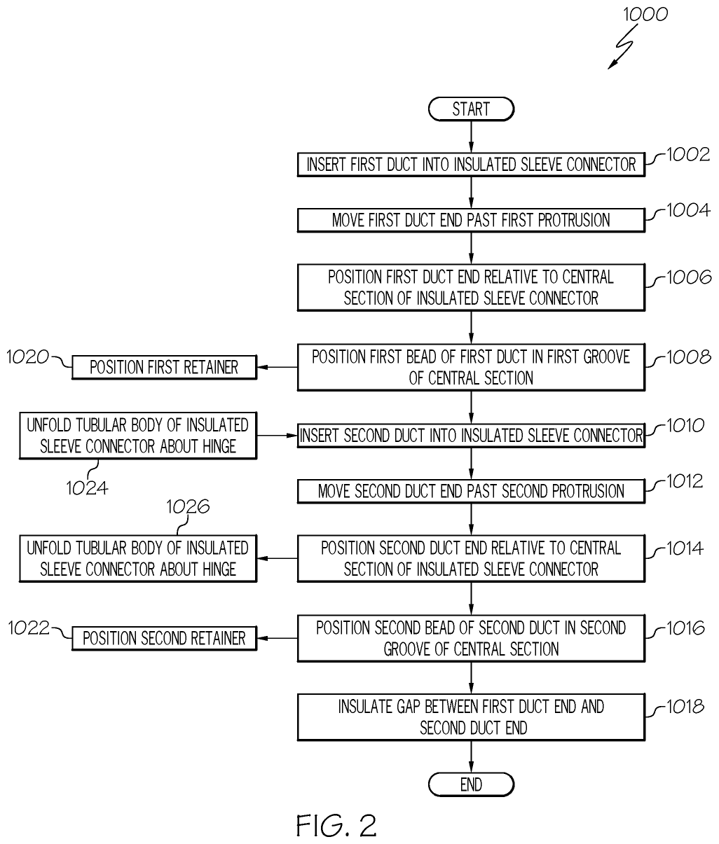

Referring generally to FIGS. 1 and 3-15 and particularly to FIG. 2, the following are examples of the method 1000, according to the present disclosure. In one or more examples, the method 1000 is implemented using the insulated sleeve connector 100 (FIGS. 1 and 3-15). The method 1000 includes a number of elements, steps, operations, or processes. Not all of the elements, steps, operations, or processes described or illustrated in one example are required in that example. Some or all of the elements, steps, operations, or processes described or illustrated in one example can be combined with other examples in various ways without the need to include other elements, steps, operations, or processes described in those other examples, even though such combination or combinations are not explicitly described or illustrated by example herein.

In one or more examples, the method 1000 includes a step of inserting 1002 the first duct 254 into the first end 112 of the tubular body 102 of the insulated sleeve connector 100.

In one or more examples, the method 1000 includes a step of moving 1004 the first duct end 272 past the first protrusion 160. The first protrusion 160 projects from the inner surface 136 of the tubular body 102 adjacent to the central section 122 of the tubular body 102.

In one or more examples, the method 1000 includes a step of positioning 1006 the first duct end 272 of the first duct 254 within the central section 122 of the tubular body 102.

In one or more examples, the method 1000 includes a step of positioning 1008 the first bead 262 in the first groove 132. The first groove 132 is disposed on the inner surface 136 of the tubular body 102 along the central section 122.

In one or more examples, the method 1000 includes a step of inserting 1010 the second duct 256 into the second end 116 of the tubular body 102.

In one or more examples, the method 1000 includes a step of moving 1012 the second duct end 274 past the second protrusion 170. The second protrusion 170 projects from the inner surface 136 of the tubular body 102 adjacent to the central section 122 and is spaced away from the first protrusion 160 along the longitudinal axis 104.

In one or more examples, the method 1000 includes a step of positioning 1014 the second duct end 274 of the second duct 256 within the central section 122 of the tubular body 102. In one or more examples, the first duct 254 and the second duct 256 are positioned such that the distance 286 between the first duct end 272 and the second duct end 274 is less than the length dimension 162 of the central section along the longitudinal axis 104.

In one or more examples, the method 1000 includes a step of positioning 1016 the second bead 264 in the second groove 134. The second groove 134 is disposed on the inner surface 136 of the tubular body 102 along the central section 122 and is spaced from the first groove 132 along the longitudinal axis 104.

In one or more examples, the method 1000 includes a step of insulating 1018 the gap 258 between the first duct end 272 and the second duct end 274 with the central section 122. In one or more examples, the step of insulating 1018 is performed or achieved by the insulated sleeve connector 100 being connected to the end portions of the ducts 252, for example, by the insulating material 124 used to form at least a portion of the insulated sleeve connector 100, the thickness of the tubular body 102, the thickness of the insulating material 124, the relative position of the insulating material 124 and/or the insulated layer 108, and the like.

In one or more examples, the method 1000 includes a step of positioning 1020 the first retainer 166 along the first section 126 of the tubular body 102 extending along the longitudinal axis 104 between the first end 112 and the central section 122.

In one or more examples, the method 1000 includes a step of positioning 1022 the second retainer 168 along the second section 128 of the tubular body 102 extending along the longitudinal axis 104 between the second end 116 and the central section 122.

In one or more examples, the method 1000 includes a step of folding 1024 the second section 128 of the tubular body 102, extending along the longitudinal axis 104 between the second end 116 and the central section 122, back along the longitudinal axis 104 about the hinge 164. The step of folding 1024 reduces the length of the tubular body 102 for installation on one of the ducts 252. In one or more examples, the step of folding 1024 is performed before the step of inserting 1010 the second duct 256 into the insulated sleeve connector 100 (e.g., FIG. 7).

In one or more examples, the method 1000 includes a step of unfolding 1026 the second section 128 of the tubular body 102 along the longitudinal axis 104 about the hinge 164. The step of unfolding 1026 returns the tubular body 102 to its original length for installation on one of the ducts 252. In one or more examples, the step of unfolding 1026 is performed after the step of inserting 1010 the second duct 256 into the insulated sleeve connector 100, such as after the step of positioning 1014 the second duct 256 relative to the central section 122 (FIG. 8).

In one or more examples, according to the method 1000, the step of positioning 1022 the second retainer 168 includes a step of moving the second retainer 168 along the ramp 172 between the first section 126 and the second section 128 to the hinge 164.

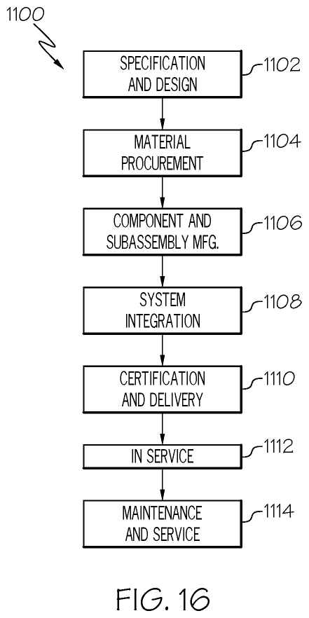

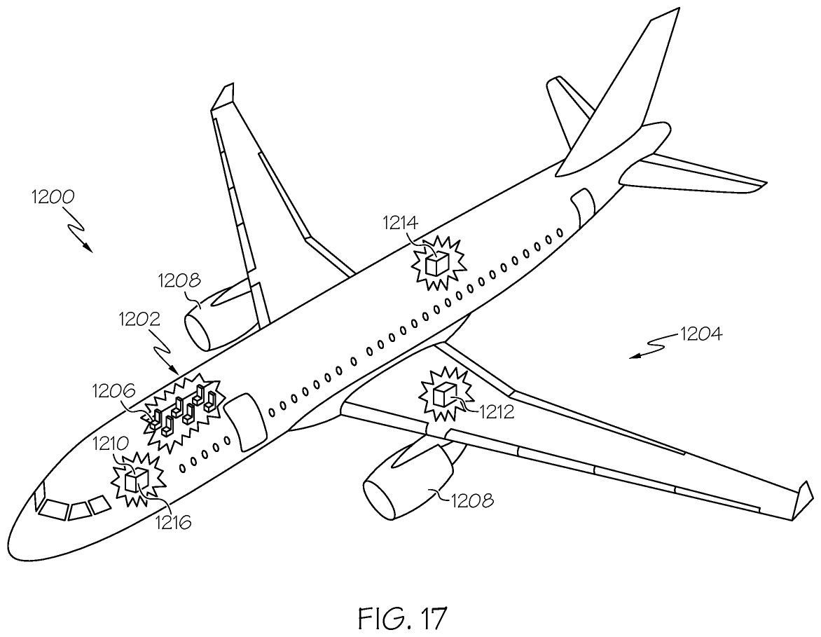

Referring now to FIGS. 16 and 17, examples of the insulated sleeve connector 100, the duct system 250, and the method 1000 described herein, may be related to, or used in the context of, the aerospace manufacturing and service method 1100, as shown in the flow diagram of FIG. 16 and an aircraft 1200, as schematically illustrated in FIG. 17. As an example, the aircraft 1200 and/or the manufacturing and service method 1100 may include or utilize the duct system 250 that includes the ducts 252 connected using the insulated sleeve connector 100.

Referring to FIG. 17, which illustrates an example of the aircraft 1200. The aircraft 1200 can be any aerospace vehicle or platform. In one or more examples, the aircraft 1200 includes the airframe 1202 having the interior 1206. The aircraft 1200 includes a plurality of onboard systems 1204 (e.g., high-level systems). Examples of the onboard systems 1204 of the aircraft 1200 include propulsion systems 1208, hydraulic systems 1212, electrical systems 1210, and environmental systems 1214. In other examples, the onboard systems 1204 also includes one or more control systems coupled to the airframe 1202 of the aircraft 1200. In yet other examples, the onboard systems 1204 also include one or more other systems 1216, such as, but not limited to, communications systems, avionics systems, software distribution systems, network communications systems, passenger information/entertainment systems, guidance systems, radar systems, weapons systems, and the like. The aircraft 1200 can include the duct system 250 having the ducts 252 that are connected together using the insulated sleeve connector 100.

Referring to FIG. 16, during pre-production of the aircraft 1200, the manufacturing and service method 1100 includes specification and design of the aircraft 1200 (block 1102) and material procurement (block 1104). During production of the aircraft 1200, component and subassembly manufacturing (block 1106) and system integration (block 1108) of the aircraft 1200 take place. Thereafter, the aircraft 1200 goes through certification and delivery (block 1110) to be placed in service (block 1112). Routine maintenance and service (block 1114) includes modification, reconfiguration, refurbishment, etc. of one or more systems of the aircraft 1200.

Each of the processes of the manufacturing and service method 1100 illustrated in FIG. 16 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

Examples of the insulated sleeve connector 100, the duct system 250, and the method 1000, shown and described herein, may be employed during any one or more of the stages of the manufacturing and service method 1100 shown in the flow diagram illustrated by FIG. 16. In an example, the duct system 250 of the aircraft 1200 can be installed or connected using the insulated sleeve connector 100 and/or according to the method 1000 during a portion of component and subassembly manufacturing (block 1106) and/or system integration (block 1108). Further, the duct system 250 of the aircraft 1200 can be installed or connected using the insulated sleeve connector 100 and/or according to the method 1000 while the aircraft 1200 is in service (block 1112). Also, the duct system 250 of the aircraft 1200 can be installed or connected using the insulated sleeve connector 100 and/or according to the method 1000 during system integration (block 1108) and certification and delivery (block 1110). Similarly, the duct system 250 of the aircraft 1200 can be installed or connected using the insulated sleeve connector 100 and/or according to the method 1000 while the aircraft 1200 is in service (block 1112) and during maintenance and service (block 1114).

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of”' may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, clement A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1, 3-5 and 17, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1, 3-5 and 17, referred to above, need be included in every example and not all elements, features, and/or components described herein are necessarily depicted in each illustrative example. Accordingly, some of the elements, features, and/or components described and illustrated in FIGS. 1, 3-5 and 17 may be combined in various ways without the need to include other features described and illustrated in FIGS. 1, 3-5 and 17, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1, 3-5 and 17, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1, 3-5 and 17, and such elements, features, and/or components may not be discussed in detail herein with reference to each of FIGS. 1, 3-5 and 17. Similarly, all elements, features, and/or components may not be labeled in each of FIGS. 1, 3-5 and 17, but reference numerals associated therewith may be utilized herein for consistency.

In FIGS. 2 and 16, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIGS. 2 and 16 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the insulated sleeve connector 100, the duct system 250, and the method 1000 have been shown and described, modifications may occur to those skilled in the art upon reading the specification. The present application includes such modifications and is limited only by the scope of the claims.

1. An insulated sleeve connector comprising:
a tubular body having a longitudinal axis and comprising:
a first end comprising a first opening;
a second end opposite the first end along the longitudinal axis and comprising a second opening; and
a central section situated along the longitudinal axis between the first end and the second end and comprising an insulating material;
a first protrusion projecting from an inner surface of the tubular body adjacent to the central section; and
a second protrusion projecting from the inner surface of the tubular body adjacent to the central section and spaced away from the first protrusion along the longitudinal axis.

2-3. (canceled)

4. The insulated sleeve connector of claim 1, wherein:
the tubular body further comprises:
a first section extending along the longitudinal axis between the first end and the central section; and
a second section extending along the longitudinal axis between the second end and the central section;
the first section of the tubular body is configured to receive a first duct;
the second section of the tubular body is configured to receive a second duct; and
the central section of the tubular body has a length dimension along the longitudinal axis that is greater than a distance between a first duct end of the first duct and a second duct end of the second duct when the first duct is received by the first section and the second duct is received by the second section.

5. The insulated sleeve connector of claim 4, further comprising:
a first groove disposed on an inner surface of the tubular body along the central section, wherein the first groove is configured to receive a first bead of the first duct; and
a second groove disposed on the inner surface of the tubular body along the central section and spaced from the first groove along the longitudinal axis, wherein the second groove is configured to receive a second bead of the second duct.

6. The insulated sleeve connector of claim 5, wherein:
the first groove has a first groove width that is larger than a first bead width of the first bead; and
the second groove has a second groove width that is larger than a second bead width of the second bead.

7. The insulated sleeve connector of claim 4, wherein at least one of the first section and the second section of the tubular body comprises the insulating material.

8. The insulated sleeve connector of claim 4, wherein:
the first protrusion is located at a first junction of the first section and the central section and provides a first tactile response to insertion of the first duct; and
the second protrusion is located at a second junction of the second section and the central section that provides a second tactile response to insertion of the second duct.

9. The insulated sleeve connector of claim 4, wherein:
the second section of the tubular body comprises a hinge; and
a portion of the second section is configured to fold back along the longitudinal axis about the hinge.

10. The insulated sleeve connector of claim 9, further comprising a second retainer, wherein the hinge is configured to receive the second retainer.

11. The insulated sleeve connector of claim 10, wherein:
the tubular body has an outer dimension along the first section that increases from the first end to the central section to form a ramp; and
the second retainer is movable along the ramp between the first section and the second section.

12. The insulated sleeve connector of claim 1, further comprising:
a number of first tabs extending outwardly from the first end along the longitudinal axis; and
a number of second tabs extending outwardly from the second end along the longitudinal axis.

13-14. (canceled)

15. The insulated sleeve connector of claim 1, further comprising:
a first flange extending from the tubular body at the first end; and
a second flange extending from the tubular body at the second end.

16. The insulated sleeve connector of claim 1, further comprising:
a first inner band coupled to an inner surface of the tubular body at the first end; and
a second inner band coupled to the inner surface of the tubular body at the second end.

17. The insulated sleeve connector of claim 16, further comprising:
a first outer band coupled to an outer surface of the tubular body at the first end; and
a second outer band coupled to the outer surface of the tubular body at the second end.

18-20. (canceled)

21. The insulated sleeve connector of claim 1, further comprising:
a number of first tabs coupled to at least one of the first inner band and first outer band and extending outwardly from the first end along the longitudinal axis; and
a number of second tabs coupled to at least one of the second inner band and the second outer band and extending outwardly from the second end along the longitudinal axis.

22. The insulated sleeve connector of claim 1, wherein the tubular body comprises:
a base layer comprising a flexible material; and
an insulated layer coupled to the base layer and comprising the insulating material.

23-24. (canceled)

25. The insulated sleeve connector of claim 2, wherein the base layer extends outwardly from the insulated layer along the longitudinal axis to form a number of first tabs extending outwardly from the first end and a number of second tabs extending outwardly from the second end.

26-50. (canceled)

51. An insulated sleeve connector comprising:
a tubular body having a longitudinal axis and comprising:
a first end comprising a first opening;
a second end opposite the first end along the longitudinal axis and comprising a second opening; and
a central section situated along the longitudinal axis between the first end and the second end and comprising an insulating material; and
a hinge disposed on the tubular body between the central section and the second end,
wherein a portion of the tubular body is configured to fold back along the longitudinal axis about the hinge.

52. The insulated sleeve connector of claim 51, wherein:
the tubular body further comprises:
a first section extending along the longitudinal axis between the first end and the central section; and
a second section extending along the longitudinal axis between the second end and the central section;
the first section of the tubular body is configured to receive a first duct;
the second section of the tubular body is configured to receive a second duct; and
the central section of the tubular body has a length dimension along the longitudinal axis that is greater than a distance between a first duct end of the first duct and a second duct end of the second duct when the first duct is received by the first section and the second duct is received by the second section.

53-77. (canceled)

78. A method for connecting ducts using an insulated sleeve connector, the method comprising:
inserting a first duct into a first end of a tubular body of the insulated sleeve connector;
moving the first duct end past a first protrusion projecting from an inner surface of the tubular body adjacent to a central section of the tubular body situated along a longitudinal axis of the tubular body between the first end and a second end of the tubular body;
positioning a first duct end of the first duct within the central section of the tubular body;
inserting a second duct into a second end of the tubular body;
moving a second duct end past a second protrusion projecting from the inner surface of the tubular body adjacent to the central section and spaced away from the first protrusion along the longitudinal axis;
positioning the second duct end of the second duct within the central section of the tubular body such that a distance between the first duct end and the second duct end is less than a length dimension of the central section along the longitudinal axis; and
insulating a gap between the first duct end and the second duct end with the central section.

79-80. (canceled)

81. The method of claim 78, further comprising folding a second section of the tubular body, extending along the longitudinal axis between the second end and the central section, back along the longitudinal axis about a hinge before inserting the second duct into the second end of the tubular body.

82-87. (canceled)
